(19) United States
(12) Patent Application Publication
(10) Pub. No.: US 2015/0340130 A1
(43) Pub. Date: Nov. 26, 2015

(54) HEAT DISSIPATION IN A POWER CABLE OR A POWER UMBILICAL

(71) Applicant: AKER SUBSEA AS, Lysaker (NO)

(72) Inventor: Jan Ole DUNSERUD, Oslo (NO)

(73) Assignee: AKER SUBSEA AS, Lysaker (NO)

(21) Appl. No.: 14/412,126

(22) PCT Filed: Jul. 4, 2013
(86) PCT No.: PCT/NO2013/000030

§ 371 Date: Dec. 30, 2014

(30) Foreign Application Priority Data
Jul. 4, 2012 (NO) 20120777

(51) Int. Cl. H01B 7/42; H01B 7/04; H01B 1/02; H01B 9/00; H01B 3/30

(52) U.S. Cl. CPC H01B 7/423; H01B 9/005; H01B 3/30; H01B 1/023; H01B 7/045

(57) ABSTRACT

A power cable, or power umbilical, comprising a number of electric cables for transfer of large amounts of electric power/energy; filler material in the form of stiff elongate polymer elements; said number of electric cables and stiff elongate polymer elements being gathered in a twisted bundle by means of a laying operation; a protective sheath that encompasses the electric cables and the filler material; wherein the filler material is manufactured of a polymer material, which polymer material has been added constituents that transforms the filler material to be substantially more heat conducting and heat dissipating.

The present invention relates to a specially designed power cable, or a power umbilical, in order to obtain substantial heat dissipation in such a power cable or power umbilical, which in the following text is referred to by the general term “power umbilical”.

Heat dissipation, or cooling, is required for cables, risers, bundles, pipe/cables bundles, all longitudinal products with embedded power cables that generate heat due to surrounding thermal insulation, stagnant hot air, trenched cables in mud or sand, heat from flowlines or other process activity. As known per se, water can be used as cooling agent, but other fluids, like antifreeze coolants, are conceivable if desired or necessary due to a particular use or circumstance. The water may be especially treated or cleaned process water. This application, however, provides additionally means to obtain increased heat dissipation and thereby improved cooling, either it being used alone, or been used in addition to such fluid cooling. Such cooling fluid can be injected or circulated by a feeding device or it may be naturally flowing due to e.g. temperature differences and/or gravity. Since cooling fluid can be used in combination with the present invention, a description and reference thereto is included.

A cooling effect may also be achieved by means of a heat pipe based on a sealed metal pipe or tube as a heat transfer device.

An example when cooling becomes necessary is described in the following section. A cable experiencing temperatures above what the materials in the cable can withstand needs to be cooled. By injecting cooling fluid trough the structure in defined channels, the temperature will fall. In a typical incident, the temperature will fall with approx. 25° C. With temperatures close to 90° C., it is of vital importance to cool the cable. The cable insulation materials that are used are normally PEX Cross Linked PE. The design limit temperature for this material is 90° C. If the cable is too warm, lowering of the temperature by 5, 10 or 15 degrees from the design limit will at least double the service life of the cable.

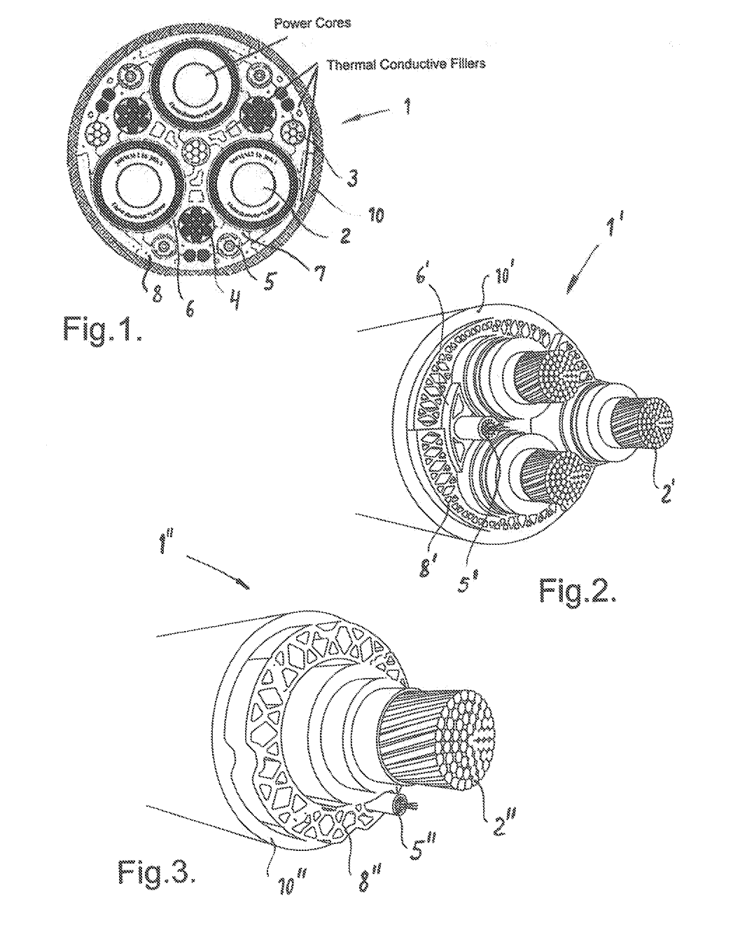

When it comes to power umbilicals, sometimes just caned power cables, like DEN cables (Direct Electric Heating) and riser designs, the DEH cables are in most cases supplied with electric power by a dynamic power cable from the topside power supply, and connected subsea to a power cable. Experiences show that the worst case regarding temperature conditions for the cables occurs in the region where the riser is above the sea water. The riser may be located inside a steel tube which increases the heat in the cable. The “traditional design” requires large conductor cross sections (1600 mm²) in order to keep the cable temperature below the limit of 90° C., which is the omit for the cable insulation XLPE. To supply three pipeline sections with the traditional design, six cable conductors are required. An alternative solution is to supply these sections with one four core and one two core riser cable. The maximum temperature occurs in the riser with four cores. Computations have been carried out given a current of 1430 A, which is required for heating a pipeline with a U-value of 2.5 Wm²k, The temperature plot for this configuration is shown in FIG. 1. As seen in the figure, the temperature limit of 90° C. is exceeded.

One possible solution, as previously suggested in PCT/NO2013/050033, herby incorporated as reference, is to reduce the temperature by using water, or another type of cooling agent, in order to cool down the inside of a riser. FIG. 2 shows a solution with water cooling supplying 20° C. water in two 16 mm in diameter pipes close to the center of the umbilical. With such a water cooling arrangement the maximum temperature is reduced to 70° C., which is well below the 90° C. limit of the cable.

In more detail the present invention relates to a power cable, or power umbilical, comprising a number of electric cables for transfer of large quantities of electric power/energy; filler material in the form of stiff elongate polymer elements located at least partially around and between the number of electric cables, the number of electric cables and stiff elongate polymer elements being gathered in a twisted bundle by means of a laying operation; a protective sheath that encompasses the electric cables and the filler material; and optionally at least one load carrying element at a predetermined location in the cross section of the power cable/umbilical.

The number of electric cables, the stiff elongate polymer elements and the at least one load carrying element, are either laid in a continuous helix, or alternately laid, i.e. by continuously alternating direction, in the entire or part of the longitudinal extension of the power cable/umbilical, to form a bundle.

According to the present invention an arrangement of the introductory said kind is provided, which arrangement is distinguished in that each stiff elongate polymer filler element is manufactured of said polymer material, which polymer material has been added at least one constituent that transforms the filler material to be substantially more heat conducting and heat dissipating.

In some embodiments of the invention, the said polymer material may be limited to a plastic material.

The base polymer filler material may be either one of polyethylene (PE), polyvinylchloride (PVC), polypropylene (PP) and acrylonitrile butadiene styrene (ABS). One can also imagine a combination of such filler materials.

In one embodiment the base filler material can for Instance be polyvinylchloride (PVC) and the added constituents is for instance Boron-Nitride in the range of 3-15 weight %. In such an embodiment, the Boron-Nitride constituents could also be in the range of 140 weight %. Other combinations of tiller materials and other types of added constituents are however also possible,

In another embodiment the added constituent can be Aluminium Nitride In the range of 1-40 weight %.

In still another embodiment the added constituent can be Carbon nano pipes in the range of 1-3 weight %, either alone or together with any of the other constituents.

In yet another embodiment the added constituent can be graphene in the range of 0.3-3 weight %, either alone or together with any of the other constituents.

Further, in another embodiment, at least one longitudinally extending channel is provided for forced flow transportation of a cooling agent through said power cable/umbilical in order to additionally cool down the electric cables and their insulation material from a critical temperature value of about 90° C.

In another embodiment, the channels further include gaps, slits or any openings, extending transversally and/or longitudinally in said power cable/umbilical, said channels, gaps and slits enable flooding of the internals of said power cable/umbilical, which flooding enables heat transfer from the electric cables to the cooling agent for evacuation of said heat.

In still another embodiment, the at least one longitudinally extending channel is terminating on board a vessel at an umbilical hangoff point comprising cooling agent tubes connecting with said one or more channels for transfer of said agent under pressure.

Further, the at least one longitudinally extending channels may be provided with draining holes through the outer sheath and communicating with said channels, which in turn communicate the coding agent into the sea.

Preferably, the cooling agent is pure water, especially treated water or cleaned process water.

The cooling length of the power cable/umbilical may very and can extend over a length such as 50-200 meters, where one crucial length regarding heat build up is in the section of open air from the umbilical hangoff point to the sea surface.

The power cable, or power umbilical, may in one embodiment include at least one fluid pipe in the cross section, made of metal and/or plastic material.

In one embodiment, the filler material and the added constituent are continuously mixed together during production of the power cable or power umbilical. In such an embodiment one does not need to mix the filler and constituent in advance. Moreover one is able to adjust the weight-% of the respective components arbitrarily during production, according to requirements for the umbilical in question.

Other and further objects, features and advantages will appear from the following description of preferred embodiments of the invention, which is given for the purpose of description, and given in context with the appended drawings where:

FIG. 1 shows a typical transverse cross sectional view of a power cable having three power conductors,

FIG. 2 shows another typical transverse cross sectional view of a power cable having three power conductors, and

FIG. 3 shows a typical transverse cross sectional view of a variant of a power cable having one power conductor only.

Reference is firstly made to FIG. 1 showing a power cable 1, also called a power umbilical by persons versed in the art. The power cable 1 has three power conductor cores 2 of substantial transversal cross section which are designed to transfer large quantities of electric power. The three power conductor cores 2 are normally made of copper, but aluminum or other conductive materials are also conceivable.

Further elements in the cross section can be load carrying elements 3 and weight elements 4, in addition to optical conductors 5. Finally there is a bundle of filler elements 6, 7 and 8. The filler elements are typically stiff elongate polymer elements, also called channel elements which are located at least partially around and between the electric power conductors 2, the load carrying elements 3, the weight elements 4 and the optical conductors 5. In the depicted version there are three inner channel elements 6, three intermediate channel elements 7 and six outer channel elements 8. The six outer channel elements 8 are three of each type having different cross section but are designed to fit into each other along their longitudinal edges.

Each of these stiff elongate polymer filler elements manufactured of this polymer material, has been added at least one constituent that transforms the filler material to be substantially more heat conducting and heat dissipating. Such base polymer filler material is typically either one of polyethylene (PE), polyvinylchloride (PVC), polypropylene (PP) or acrylonitrile butadiene styrene (ABS). The added constituent can be Boron Nitride in the range of 1-40 weight %. Another added constituent can be Aluminium Nitride in the range of 1-40 weight %. Another added constituent can be Carbon nano pipes in the range of 1-3 weight %.

As an example only, the power cable 1 can be a DEH cable having three heavy gauge conductors 2, each having a transversal cross section area of 1600 mm², an outer diameter of 72.5 mm and a capacity of 6/10 kV.

The channel elements 6, 7, 8 may have cooling fluid channels provided in their profile.

All these elements are gathered in a twisted bundle that was made by means of a laying and closing operation in a per se known manner. A protective sheath 10 encompasses the entire bundle of the above listed elements.

Reference is now made to FIG. 2 showing a simpler power cable 1′. The power cable 1′ still has three power conductor cores T of substantial transversal cross section which are designed to transfer large quantities of electric power. The three power conductor cores 2′ are, as before, normally made of copper, but aluminum or other conductive materials are also conceivable.

Further elements in the cross section are one or more optical conductors 5′. Further there is a bundle of filler elements 6′ and 8′. The filler elements are typically stiff elongate polymer elements, also called channel elements. In the depicted version there are three inner channel elements 6′ and three outer channel elements 8′.

Reference is now made to FIG. 3 showing a still simpler power cable 1″. The power cable 1″ has only one power conductor core 2″ of substantial transversal cross section which are designed to transfer large quantities of electric power. The single power conductor core 2″ is, as before, normally made of copper, but aluminum or other conductive materials are also conceivable.

Further elements in the cross section are one or more optical conductors 5″. Further there are three circumferentially extending filler elements and 8″. The filler elements are typically stiff elongate polymer elements, also called channel elements.

### Temperature Challenges and Cable Design

One of the most important parameters in DEC (Direct Electric Heating Cable) design is the temperature. The temperature of the cable varies trough the different operational conditions trough different parts of the system, from topside I-tube, bend stiffener, trench along the flowline etc. High voltage (HV) cables can be subjected to high temperatures and seawater in these areas. Such conditions can limit the electrical and mechanical lifetime of the polymer materials used in the cable design. The cable temperature should be kept wall below the limit of 90° C. by choosing a sufficient cable conductor cross section to improve the service life.

A DEHC consists of an insulation system (semi-conductive insulation screens and an insulating material, typically cross-linked polyethylene: XLPE. In addition, in order to prevent water flowing longitudinally (e.g. after a cable service failure) hi the conductor, a semi-conductive sealing material are filled in between the strands.

The DEHC design needs some modifications to the traditional HV cable design since the water barrier in such a traditional cable is made of metallic materials which will have negative effect on the heating effect. The DEHC has therefore got a wet design.

1. A power cable, or power umbilical, comprising:
a number of electric cables for transfer of large quantities of electric power/energy;
filler material in the form of stiff elongate polymer elements located at least partially around and between the number of electric cables, the number of electric cables and stiff elongate polymer elements being gathered in a twisted bundle by means of a laying operation;
a protective sheath that encompasses the electric cables and the filler material; and
at least one load carrying element at a predetermined location in the cross section of the power cable/umbilical,
the number of electric cables, the stiff elongate polymer elements and the at least one load carrying element, are either laid in a continuous helix, or alternately laid, i.e. by continuously alternating direction, in the entire or part of the longitudinal extension of the power cable/umbilical, to form a bundle, and
wherein each stiff elongate polymer filler element is manufactured of said polymer material, which polymer material has been added at least one constituent that transforms the filler material to be substantially more heat conducting and heat dissipating.

2. The power cable, or power umbilical, according to claim 1, herein the base polymer filler material is either one of polyethylene (PE), polyvinylchloride (PVC), polypropylene (PP) and acrylonitrile butadiene styrene (ABS).

3. The power cable, or power umbilical, according to claim 1, wherein the added constituent is Boron Nitride in the range of 1-40 weight %.

4. The power cable, or power umbilical, according to claim 1, wherein the added constituent is Aluminium Nitride in the range of 1-40 weight %.

5. The power cable, or power umbilical, according to claim 1, wherein the added constituent is Carbon nano pipes in the range of 1-3 weight %.

6. The power cable, or power umbilical, according to claim 1, wherein the filler material and the added constituent are mixed continuously and incorporated into the power cable or power umbilical during production of the same.

7. The power cable, or power umbilical, according to claim 1, wherein at least one longitudinally extending channel is provided for forced flow transportation of a cooling agent through said power cable/umbilical in order to additionally cool down the electric cables and their insulation material from a critical temperature value of about 90° C.

8. The power cable, or power umbilical, according to claim 7, wherein the channels further include gaps, slits or any openings, transversally and/or longitudinally extending in said power cable/umbilical, said channels, gaps and slits enable flooding of the internals of said power cable/umbilical, which flooding enables heat transfer from the electric cables to the cooling agent for evacuation of said heat.

9. The power cable, or power umbilical, according to claim 7, wherein the at least one longitudinally extending channels are terminating on board a vessel at an umbilical hangoff point comprising cooling agent tubes connecting with said channels for transfer of said agent under pressure.

10. The power cable, or power umbilical, according to claim 7, wherein the at least one longitudinally extending channel is provided with draining holes through the outer sheath and communicating with said channels, which communicate the cooling agent into the sea.

11. The power cable, or power umbilical, according to claim 7, wherein the cooling agent is water.

12. The power cable, or power umbilical, according to claim 7, wherein the cooling length of the power cable/umbilical extends over a length of 50-200 meters, where one crucial length is in open air from the umbilical hangoff point to the sea surface.

13. The power cable, or power umbilical, according to claim 7, wherein the power cable/umbilical comprises at least one fluid pipe in the cross section, of metal and/or plastic material.

14. The power cable, or power umbilical, according to claim 2, wherein the added constituent is Boron Nitride in the range of 1-40 weight %.

15. The power cable, or power umbilical, according to claim 2, wherein the added constituent is Aluminium Nitride in the range of 1-40 weight %.

16. The power cable, or power umbilical, according to claim 2, wherein the added constituent is Carbon nano pipes in the range of 1-3 weight %.

17. The power cable, or power umbilical, according to claim 3, wherein the added constituent is Carbon nano pipes in the range of 1-3 weight %.

18. The power cable, or power umbilical, according to claim 4, wherein the added constituent is Carbon nano pipes in the range of 1-3 weight %.

19. The power cable, or power umbilical, according to claim 2, wherein the filler material and the added constituent are mixed continuously and incorporated into the power cable or power umbilical during production of the same.

20. The power cable, or power umbilical, according to claim 3, wherein the filler material and the added constituent are mixed continuously and incorporated into the power cable or power umbilical during production of the same.
